(19) United States
(12) Patent Application Publication
(10) Pub. No.: US 2021/0142337 A1
(43) Pub. Date: May 13, 2021

(54) Product Authenticity Verification Based on Environment

(71) Applicant: EVRYTHNG Ltd, London (GB)

(72) Inventors: Dominique Guinard, Yverdon-les-Bains (CH); Joel Vogt, Commungy (CH); Niall Murphy, London (GB); Shmuel Silverman, Novato, CA (US)

(73) Assignee: EVRYTHNG Ltd, London (GB)

(21) Appl. No.: 17/095,373

(22) Filed: Nov. 11, 2020

Related U.S. Application Data
(60) Provisional application No. 62/933,980, filed on Nov. 12, 2019.

(51) Int. Cl. G06Q 30/00; G06Q 10/08; G06N 20/00; G10L 17/06; G06K 9/62

(52) U.S. Cl. CPC G06Q 30/0185; G06Q 10/087; G06K 19/0723; G10L 17/06; G06K 9/6215; G06N 20/00

(57) ABSTRACT

A computer that performs authenticity verification is described. During operation, the computer may receive information from an electronic device, where the information specifies an identifier of a product and at least one of: an environment that includes the product, or an individual associated with the product. Then, the computer may access, based at least in part on the identifier, stored second information about the product that specifies: an expected environment, an expected type of individual, and/or a history of the product. Moreover, the computer may determine a product authenticity score based at least in part on a comparison of the information and the second information. Next, the computer may selectively provide a notification to the electronic device based at least in part on the product authenticity score.

### CROSS-REFERENCE TO RELATED APPLICATION

This application claims priority under 35 U.S.C. 119(e) to: U.S. Provisional Application Ser. No. 62/933,980, “Product Authenticity Verification Based on Environment,” filed on Nov. 12, 2019, by Dominique Guinard, et al., the contents of which are herein incorporated by reference.

### BACKGROUND

### Field

The described embodiments relate to product authenticity verification. Notably, the described embodiments relate techniques that facilitate real-time product authenticity verification based at least in part on an environment of the product.

### Related Art

Because of the goodwill value of a brand, many branded products (such as consumer packaged goods and apparel products) experience a significant level of counterfeiting, e.g., in a counterfeit market or in supply chains that were not intended or that were not authorized by the brand (which is sometimes referred to as a ‘gray market’). For popular brands, these problems, which are henceforth referred to as ‘authenticity problems’, can be significant and often lead to lost revenue, lost opportunities and/or damage the brands.

Many existing approaches to addressing authenticity problems involve the use of special markers on products (e.g., holographic tags). However, the special markers are often very expensive and it can be difficult to establish their authenticity without special training and tools (such as special hardware and/or software).

### SUMMARY

In a first group of embodiments, a computer that performs authenticity verification is described. This computer may include: a network interface that communicates with an electronic device (which may be remotely located from the computer); a processor; and memory that stores program instructions. During operation, the computer may receive information associated with the electronic device, where the information specifies an identifier of a product and: an environment that includes the product, and/or an individual associated with the product. Then, the computer may access, based at least in part on the identifier, stored second information about the product that specifies: an expected environment, an expected type of individual, and/or a history of the product. Moreover, the computer may determine a product authenticity score based at least in part on a comparison of the information and the second information. Next, the computer may selectively provide a notification addressed to the electronic device based at least in part on the product authenticity score.

Note that the product authenticity score may indicate that the product is potentially fraudulent or is unauthorized when the environment is different from the expected environment. For example, the information may specify a location of the product and the expected environment may include one or more predefined locations. Alternatively or additionally, the information may specify one or more measurements in the environment, and the computer may analyze the measurement to determine one or more attributes of the environment. In some embodiments, the measurement may include: sound in the environment, an image of the environment, a temperature of the environment, a humidity of the environment, a barometric pressure of the environment, a magnetometer reading in the environment, and/or another measurement.

Moreover, the product authenticity score may indicate that the product is potentially fraudulent or is unauthorized when one or more attributes of the type of individual are different from the one or more attributes of the individual. For example, the one or more attributes may include: a nationality, a gender, an age, an annual income, and/or another socioeconomic or demographic factor. In some embodiments, the information may include recorded speech of the individual, and the computer may perform voice recognition of the individual based at least in part on the recorded speech.

Furthermore, the product authenticity score may indicate that the product is potentially fraudulent or is unauthorized when the history of the product indicates that the product has been previously sold.

Additionally, the information may include one or more images of the product and/or a tag or label associated with the product. Moreover, the second information may include one or more predetermined images of the product and/or the tag or the label associated with the product. In these embodiments, the product authenticity score may indicate that the product is potentially fraudulent or is unauthorized when the one or more images are different from the one or more predetermined images. Alternatively or additionally, the product authenticity score may indicate that the product is potentially fraudulent or is unauthorized when third information about the product included in or specified by the one or more images is different from the third information about the product included in or specified by the one or more predetermined images.

In some embodiments, the information may include third information associated with the tag or the label associated with the product. In these embodiments, the product authenticity score may indicate that the product is potentially fraudulent or is unauthorized when the third information is associated with another instance of the product.

Note that the information may include a characterization or measurement of the environment for use in a future authentication of the product (which is after or subsequent to the current authentication of the product).

Another embodiment provides a computer-readable storage medium for use with the computer. When executed by the computer, this computer-readable storage medium causes the computer to perform at least some of the aforementioned operations.

Another embodiment provides a method, which may be performed by the computer. This method includes at least some of the aforementioned operations.

A second group of embodiments provides an electronic device (which may be associated with a user). This electronic device may include: a network interface that communicates with a computer (which may be remotely located from the electronic device); a processor; and memory that stores program instructions. During operation, the electronic device may obtain information that specifies an identifier of a product and: an environment that includes the product, and/or an individual associated with the product.

For example, the electronic device may perform one or more measurements of the identifier (such as an optical measurement of the product, an optical measurement of a tag or a label associated with the product, a radio-frequency measurement of a radio-frequency identification tag associated with the product, and/or a near-field-communication measurement of the tag or label). Moreover, the electronic device may perform one or more measurements in the environment (such as a measurement that characterizes the environment and/or the individual).

Then, the electronic device may provide the information addressed to a computer that specifies the identifier of the product and: the environment that includes the product, and/or the individual associated with the product. Next, the electronic device may receive a notification associated with the computer, where the notification corresponds to a product authenticity score of the product.

In some embodiments, the electronic device may selectively perform an action based at least in part on the notification.

Another embodiment provides a computer-readable storage medium for use with the electronic device. When executed by the electronic device, this computer-readable storage medium causes the electronic device to perform at least some of the aforementioned operations.

Another embodiment provides a method, which may be performed by the electronic device. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for verifying authenticity of a product using a computer in FIG. 1 in accordance with an embodiment of the present disclosure.

FIG. 3 is a flow diagram illustrating an example of a method for verifying authenticity of a product using a computer FIG. 1 in accordance with an embodiment of the present disclosure.

FIG. 4 is a drawing illustrating an example of communication among electronic devices in FIG. 1 in accordance with an embodiment of the present disclosure.

FIG. 5 is a drawing illustrating an example of product authentication in accordance with an embodiment of the present disclosure.

FIG. 6 is a drawing illustrating an example of a product-authentication architecture in accordance with an embodiment of the present disclosure.

FIG. 7 is a flow diagram illustrating an example of a method for verifying authenticity of a product using an electronic device and a computer in FIG. 1 in accordance with an embodiment of the present disclosure.

FIG. 8 is a drawing illustrating an example of a product authentication in accordance with an embodiment of the present disclosure.

FIG. 9 is a drawing illustrating storage of information associated with a product in accordance with an embodiment of the present disclosure.

FIG. 10 is a drawing illustrating an authenticity assessment of a product in accordance with an embodiment of the present disclosure.

FIG. 11 is a drawing illustrating an authenticity assessment of a product using an environmental signature in accordance with an embodiment of the present disclosure.

FIG. 12 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer that performs authenticity verification is described. This computer may include: a network interface that communicates with an electronic device (which may be remotely located from the computer); a processor; and memory that stores program instructions. During operation, the computer may receive information from the electronic device, where the information specifies an identifier of a product and at least one of: an environment that includes the product, or an individual associated with the product. Then, the computer may access, based at least in part on the identifier, stored second information about the product that specifies: an expected environment, an expected type of individual, and/or a history of the product. Moreover, the computer may determine a product authenticity score based at least in part on a comparison of the information and the second information. Next, the computer may selectively provide a notification to the electronic device based at least in part on the product authenticity score.

By selectively providing the notification, these authenticity verification techniques may determine whether the product is potentially fraudulent (or not authentic) or is unauthorized without requiring the use of specialized tags or labels. Moreover, the authenticity verification techniques may allow a user of the electronic device (such as a cellular telephone) to check and/or confirm the authenticity and/or provenance of the product in a seamless manner and without requiring special training. Consequently, the authenticity verification techniques may provide improved authentication of products. This capability may reduce or eliminate counterfeiting of the products and unauthorized use of brands associated with the products. Thus, the authenticity verification techniques may facilitate an increase in authorized commercial activity, may improve user confidence in products, and may improve the user experience when determining whether a product is authentic.

In some embodiments, the authenticity verification techniques may determine whether a product is potentially fraudulent (or not authentic) or is unauthorized in a centralized or a distributed or decentralized manner. The decentralized embodiments may provide resilience, because the authenticity information may be stored or maintained in a decentralized network that includes many nodes.

Moreover, in the discussion that follows, electronic devices may communicate packets or frames with wired and/or wireless networks (e.g., via access points, radio nodes or base stations) in accordance with a wired communication protocol (such as an Institute of Electrical and Electronics Engineers or IEEE 802.3 standard, which is sometimes referred to as ‘Ethernet’, or another type of wired interface) and/or a wireless communication protocol, such as: an IEEE 802.11 standard (which is sometimes referred to as ‘Wi-Fi,’ from the Wi-Fi Alliance of Austin, Tex.), Bluetooth (from the Bluetooth Special Interest Group of Kirkland, Wash.), a cellular-telephone communication protocol (such as 2G, 3G, 4G, 5G, Long Term Evolution or LTE, another cellular-telephone communication protocol, etc.) and/or another type of wireless interface. In the discussion that follows, Wi-Fi, a cellular-telephone communication protocol and Ethernet are used as an illustrative example. However, a wide variety of communication protocols (such as) may be used. The wireless communication may occur in a variety of frequency bands, such as: a cellular-telephone communication band, a frequency band associated with a Citizens Band Radio Service, a Wi-Fi frequency band (such as a 2.4 GHz, a 5 GHz and/or a 60 GHz frequency band), etc.

FIG. 1 presents a block diagram illustrating an example of communication among one or more of electronic devices 110 and 112 (such as a cellular telephone, a computer, etc., and which are sometimes referred to as ‘clients’), access point 114, base station 116 in cellular-telephone network 118, and one or more computers 120 in computer system 122 in accordance with some embodiments. Access point 114 and base station 116 may communicate with computer system 122 via network 124 (such as the Internet) using wireless and/or wired communication (such as by using Ethernet or a communication protocol that is compatible with Ethernet), and may communicate with electronic device 110 using wireless communication (Wi-Fi and a cellular-telephone communication protocol, respectively). Note that access point 114 may include a physical access point and/or a virtual access point that is implemented in software in an environment of an electronic device or a computer. In addition, access point 114 and/or base station 116 may communicate with electronic devices 110 using wireless communication, while electronic device 112 may communicate with computer system 122 via network 124.

While not shown in FIG. 1, the wired and/or wireless communication with electronic devices 110 and/or 112 may further occur via an intra-net, a mesh network, point-to-point connections, etc., and may involve one or more routers and/or switches. Furthermore, the wireless communication may involve: transmitting advertising frames on wireless channels, detecting one another by scanning wireless channels, establishing connections (for example, by transmitting association or attach requests), and/or transmitting and receiving packets or frames (which may include the association requests and/or additional information as payloads). In some embodiments, the wired and/or wireless communication in FIG. 1 also involves the use of dedicated connections, such as via a peer-to-peer (P2P) communication technique.

As described further below with reference to FIG. 12, electronic device 110, electronic device 112, access point 114, base station 116, and/or computers 120 may include subsystems, such as a networking subsystem, a memory subsystem and a processor subsystem. In addition, electronic device 110, access point 114 and base station 116 may include radios 126 in the networking subsystems. More generally, electronic device 110, electronic device 112 and access point 114 can include (or can be included within) any electronic devices with the networking subsystems that enable electronic device 110 and access point 114 to communicate with each other using wireless and/or wired communication. This wireless communication can comprise transmitting advertisements on wireless channels to enable access point 114 and/or electronic device 110 to make initial contact or detect each other, followed by exchanging subsequent data/management frames (such as association requests and responses) to establish a connection, configure security options (e.g., Internet Protocol Security), transmit and receive packets or frames via the connection, etc. Note that while instances of radios 126 are shown in electronic device 110 and access point 114, one or more of these instances may be different from the other instances of radios 126.

As can be seen in FIG. 1, wireless signals 128 (represented by a jagged line) are transmitted from radio 126-1 in electronic device 110. These wireless signals may be received by radio 126-2 in access point 114. Notably, electronic device 110 may transmit packets or frames. In turn, these packets or frames may be received by access point 114. Moreover, access point 114 may allow electronic device 110 to communicate with other electronic devices, computers and/or servers via network 124.

Note that the communication among components in FIG. 1 may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

In the described embodiments processing a packet or frame in electronic device 110 and/or access point 114 includes: receiving signals (such as wireless signals 128) with the packet or frame; decoding/extracting the packet or frame from received wireless signals 128 to acquire the packet or frame; and processing the packet or frame to determine information contained in the packet or frame.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, in order to prevent counterfeiting and/or unauthorized use of a brand, many products include specialized markers. However, these special markers are often very expensive and it can be difficult to establish their authenticity without special training and tools (such as special hardware and/or software).

As described further below with reference to FIGS. 2-11, in order to address these problems, in the authenticity verification techniques a user may use one of electronic devices 110 and 112 (such as electronic device 110) to obtain information that specifies an identifier of a product (such as a physical product) and: an environment that includes the product, and/or an individual associated with the product. For example, electronic device 110 may perform one or more measurements of the identifier (such as an optical measurement of the product, an optical measurement of a tag or a label associated with the product (such as using an imaging sensor, e.g., a CMOS or a CCD sensor, a barcode scanner or a scanner device), a radio-frequency measurement of a radio-frequency identification tag associated with the product, and/or a near-field-communication measurement of the tag or label).

Note that the identifier may include or may be compatible with one or more of: a global standards 1 (GS1) digital link, a global trade item number (GTIN), a serial shipping container (SSCC), a serialized global trade item number (SGTIN), an European article number code (EAN), a universal product codes (UPC), an electronic product code (EPC), a global location number (GLN), an international standard book identifier (ISBN), a global returnable assess identifier (GRAI), a global coupon number (GCN), an Amazon standard identification number (ASIN), a global returnable asset identifier (GRAI), a global shipment identification number (GSIN), a universally unique identifier (UUID), a global document type identifier (GDTY), a globally unique identifier (GUID), an Eddystone UID or EID, an international mobile equipment identity (IMEI), an eSIM identifier, a pharmaceutical product identifier (PhPID), a serial number, or another identifier.

Moreover, electronic device 110 may perform one or more measurements in or of the environment (such as a measurement that characterizes the environment and/or the individual). Notably, electronic device 110 may: acquire one or more images of the environment and/or the individual, measure sound of the individual (such as speech and/or one or more images of the individual, which may be used for voice, facial and/or biometric identification) and/or of the environment, a temperature of the environment, a barometric pressure in the environment, a humidity of the environment, a magnetometer reading in the environment, and/or another measurement. Furthermore, electronic device 110 may acquire one or more images of the product and/or the tag or label associated with the product. Note that the measurement(s) may be performed directly by one or more sensors in electronic device 110 or by another electronic device that communicates with electronic device 110.

In some embodiments, the product may include one or more indicia (such as in and/or on the product, in or on the tag or label, or both). The one or more indicia may include a distinguishing marking or an indication associated with the product, and the one or more indicia may specify the identifier. For example, the one or more indicia may be included in or specified by: a barcode (such as a two-dimensional or 2D barcode), a watermark, a radio-frequency identification tag, and/or an a near-field communication tag. Furthermore, the one or more indicia may specify a uniform resource locator (such as a location or address of at least a computer, such as computer 120-1, which may be accessed via an application programming interface). Additionally, electronic device 110 may optionally determine the identifier based at least in part on the one or more indicia and/or from one or more measurements (such as one or more images) of the product and/or the tag or label.

Then, electronic device 110 may provide (via one or more packets or frames) information to at least a computer (such as computer 120-1). This information may specify the identifier of the product (or, optionally, may include the identifier) and: the environment that includes the product, and/or the individual associated with the product. In some embodiments, the information may include or may specify results of one or more of the performed measurements (such as measurements of the environment, measurements of the individual, one or more images of the product and/or one or more images of the tag or label).

Computer 120-1 may receive the information. In some embodiments, computer 120-1 may obtain the identifier from the information. For example, as noted previously, the identifier may have been optionally determined by electronic device 110 and included in the information. Alternatively, computer 120-1 may determine the identifier based at least in part on information specifying the identifier.

Then, computer 120-1 may access, based at least in part on the identifier, stored second information (e.g., in local and/or remote memory) about the product. This second information may specify: an expected environment of the product (such as predefined retail environments or locations), an expected type of individual that is associated with the product (such as an expected type of customer or purchaser of the product), and/or a history of the product (such as when the product was manufactured, where the product was manufactured, a transportation history of the product, e.g., information about a transportation path of the product through a logistics system or supply chain, whether the product had been sold or purchased previously, etc.).

Moreover, computer 120-1 may determine a product authenticity score based at least in part on a comparison of the information and the second information. Notably, the product authenticity score may indicate that the product is potentially fraudulent or is unauthorized when the environment is different from the expected environment. For example, the information may specify a location of the product, either directly (such as GPS coordinates, triangulation and/or trilateration information, a cellphone carrier in a city, a state, or a country, etc.) and/or indirectly (such as a temperature, a barometric pressure, a magnetometer reading, from the sound in the environment, e.g., a language spoken by other individuals in the environment, one or more images of the environment, etc.) and the expected environment may include one or more predefined locations (such as predefined locations of authorized retailers or retail locations). Alternatively or additionally, the information may specify one or more measurements in the environment (which may have been performed by the electronic device), and the computer may analyze the measurement to determine one or more attributes of the environment (and, more generally, one or more authenticity features). For example, the temperature, the barometric pressure, the magnetometer reading, the sound in the environment and/or the one or more images of the environment may be analyzed to determine the one or more attributes (such as the location, a time of day, whether the environment is indoors or outdoors, identities of one or more individuals in the environment, which may include the individual, how upscale the environment is in terms of the quality and/or price of other products in the environment, etc.). Thus, if the product is typically sold in certain retail establishments along with one or more other products (from the same manufacturer or brand, or from another manufacturer or brand), the presence (or absence) of the one or more other products may indicate whether the product is authentic or authorized (or not). Alternatively or additionally, if the product is typically sold or used in environments that are wet (or dry) and the one or more measurements indicate that the current environment is dry (or wet), then the product may be fraudulent or unauthorized. In some embodiments, the product authenticity score may be based at least in part on a comparison of measured sound in the environment and prerecorded sound in the second information (such as a sound or voice signature of the individual, a background sound or noise signature of the expected environment) and/or that is stored on or with the product (e.g., the product or the tag or label may store speech of the individual, which may be provided to computer 120-1 to facilitate subsequent voice recognition of the individual).

Furthermore, the product authenticity score may indicate that the product is potentially fraudulent or is unauthorized when one or more attributes of the type of individual are different from the one or more attributes of the individual (and, more generally, one or more authenticity features). For example, the one or more attributes may include: a nationality, a gender, an age, an annual income, and/or another socioeconomic or demographic factor. In some embodiments, the information may include recorded speech of the individual, and the computer may perform voice recognition of the individual based at least in part on the recorded speech. Based at least in part on the identity of the individual, computer 120-1 may determine whether the individual has previously purchased the product (or is the current registered user or owner of the product). If the individual has not previously purchased the product, it may indicate that the product is fraudulent or unauthorized. Alternatively, a large volume of purchases by the individual in a short time interval (such as a day, a week or a month) may indicate fraudulent activity.

Note that the product authenticity score may indicate that the product is potentially fraudulent or is unauthorized when the history of the product indicates that the product has been previously sold. For example, if a tag or a label of a product was copied and placed on a counterfeit product, then the fact that the original product has already been sold or purchased will indicate that the current product is likely fraudulent.

Additionally, as noted previously, the information may include one or more images of the product and/or a tag or label associated with the product. Moreover, the second information may include one or more predetermined images of the product and/or the tag or the label associated with the product (which may be acquired and stored when the product was manufactured and/or at different times or locations during transportation in a logistics system or supply chain). In these embodiments, the product authenticity score may indicate that the product is potentially fraudulent or is unauthorized when the one or more images are different from the one or more predetermined images. For example, if a label or a tag is copied and used on a different product or another instance of the product, then the one or more images of the label or tag may not match the one or more predetermined images. Alternatively or additionally, information about the product that is included in the label or the tag may be different from the corresponding information about the product that is included in or specified by the one or more predetermined images of the product and/or the label or the tag. In some embodiments, the product authenticity score may indicate that the product is potentially fraudulent or is unauthorized when information about the product that is included in or specified by the one or more predetermined images of the product is different from the corresponding information about the product that is included in or specified by the one or more predetermined images of the product and/or the label or the tag. Thus, if the product has the wrong size, shape and/or color, it may be determined to be fraudulent or unauthorized.

Note that analysis of a given image in the authenticity verification techniques may involve the use of one or more image analysis techniques to extract one or more authenticity features. For example, the extracted authenticity features may include: edges, corners, lines, conic shapes, color regions, texture, and/or text. In some embodiments, the features are extracted using a description technique, such as: scale invariant feature transform (SIFT), speed-up robust features (SURF), a binary descriptor (such as ORB), binary robust invariant scalable keypoints (BRISK), fast retinal keypoint (FREAK), etc. Alternatively or additionally, the image analysis may involve one or more supervised or machine-learning techniques to extract authenticity features, such as: support vector machines, classification and regression trees, logistic regression, LASSO, linear regression, another (linear or nonlinear) supervised-learning technique, and/or a neural network (such as a convolutional neural network).

In some embodiments, the product authenticity score may have three values (such as low risk, moderate risk and high risk) or may be quantitative (such as an authenticity probability equal to or between 0 and 100%). Moreover, the product authenticity score may be calculated as a weighted summation of different authenticity features, such as: whether the environment is different from the expected environment, whether the individual is different from the expected type of individual, etc. However, the presence of certain features (such as repeated purchases of a product by the individual, e.g., more than three purchases in a week, previous sale or purchase or the product or the product associated with the identifier, differences between the one or more images and the one or more predetermined images, etc.) may minimize the product authenticity score (such as high risk or 0%.). In some embodiments, the product authenticity score is determined from one or more authenticity features using one or more pretrained machine-learning model and/or one or more pretrained neural networks (such as a convolutional neural network or a recursive neural network), which use the one or more authenticity features as inputs, and which output the product authenticity score. For example, the one or more machine-learning models may be training using an unsupervised technique (such as clustering) and/or a supervised technique, such as: support vector machines, classification and regression trees, logistic regression, LASSO, linear regression, and/or another (linear or nonlinear) supervised-learning technique. Note that the one or more pretrained machine-learning model and/or one or more pretrained neural networks may have been trained using data for one or more additional products that are related to (but different from) the product, such as one or more additional instances of the product, one or more additional products in a similar category of products to the product, etc.

After determining the product authenticity score, computer 120-1 may selectively provide a notification to electronic device 110 based at least in part on the product authenticity score. For example, computer 120-1 may compare the product authenticity score and a threshold value (such as 25, 50 or 75%). Thus, when the product authenticity score is less than (or greater than) the threshold value, computer 120-1 may provide the notification indicating that the product is not authentic (or is authentic). In some embodiments, computer 120-1 may selectively provide a notification to another computer (not shown), such as a computer associated with a manufacturer or an owner of a brand associated with the product, a computer associated with a law enforcement agency, etc., based at least in part on the product authenticity score.

After receiving the notification, electronic device 110 may selectively perform an action based at least in part on the notification. For example, electronic device 110 may display the notification, may illuminate a light (such as a red or green light) and/or may output a sound (such as a warning or a pleasant sound of approval). In some embodiments, the action may include: cancelling or discontinuing a financial transaction (such as purchase of the product), seizing the product, notifying a law enforcement agency, etc.

In these ways, at least computer 120-1 in computer system 122 may determine whether the product is authentic without requiring the use of special tags or training. Consequently, at least computer 120-1 may enhance trust in the product, and may reduce or eliminate counterfeiting of the product and/or unauthorized use of a brand associated with the product.

While the preceding discussion illustrated the authenticity verification techniques using particular authenticity features, more generally the product authenticity score may be determined using a signature corresponding to at least one or more attributes of features of the environment (which may include one or more environmental conditions) and/or the individual. Note that the signature may correspond to one or more authenticity features and/or measurements (such as sound in the environment and/or a voice signature of the individual). The signature may provide contextual information about the product. In some embodiments, the contextual information may include missing information about the product and/or contradictory information about the product (such as based at least in part on a comparison of the one or more images of the product and/or the label or the tag and the one or more predetermined images.

Moreover, while the preceding discussion illustrated computer 120-1 (which is remote from electronic device 110) performing at least a portion of the authenticity verification techniques, in other embodiments one or more of the operations performed by computer 120-1 are performed locally (e.g., by a computer that is proximate to electronic device 110 or by electronic device 110).

We now describe embodiments of a method. FIG. 2 presents a flow diagram illustrating an example of a method 200 for verifying authenticity of a product using a computer, such as one of computers 120 (FIG. 1). During operation, the computer may receive information (operation 210) from an electronic device, where the information specifies an identifier of a product and: an environment that includes the product, and/or an individual associated with the product.

Then, the computer may access, based at least in part on the identifier, stored second information (operation 212) about the product that specifies: an expected environment, an expected type of individual, and/or a history of the product.

Moreover, the computer may determine a product authenticity score (operation 214) based at least in part on a comparison of the information and the second information. Note that the product authenticity score may indicate that the product is potentially fraudulent or is unauthorized when the environment is different from the expected environment. For example, the information may specify a location of the product and the expected environment may include one or more predefined locations. Alternatively or additionally, the information may specify one or more measurements in the environment (which may have been performed by the electronic device), and the computer may analyze the measurement to determine one or more attributes of the environment (and, more generally, to determine one or more authenticity features). In some embodiments, the measurement may include: sound in the environment, an image of the environment, a temperature of the environment, a humidity of the environment, a barometric pressure of the environment, a magnetometer reading in the environment, and/or another measurement (which may have been performed by the electronic device).

Furthermore, the product authenticity score may indicate that the product is potentially fraudulent or is unauthorized when one or more attributes of the type of individual are different from the one or more attributes of the individual. For example, the one or more attributes may include: a nationality, a gender, an age, an annual income, and/or another socioeconomic or demographic factor. In some embodiments, the information may include recorded speech of the individual, and the computer may perform voice recognition of the individual based at least in part on the recorded speech. Additionally, the product authenticity score may indicate that the product is potentially fraudulent or is unauthorized when the history of the product indicates that the product has been previously sold.

In some embodiments, the information may include one or more images of the product and/or a tag or label associated with the product. Moreover, the second information may include one or more predetermined images of the product and/or the tag or the label associated with the product. In these embodiments, the product authenticity score may indicate that the product is potentially fraudulent or is unauthorized when the one or more images are different from the one or more predetermined images. Alternatively or additionally, the product authenticity score may indicate that the product is potentially fraudulent or is unauthorized when third information about the product included in or specified by the one or more images is different from the third information about the product included in or specified by the one or more predetermined images.

Moreover, the information may include third information associated with the tag or the label associated with the product. In these embodiments, the product authenticity score may indicate that the product is potentially fraudulent or is unauthorized when the third information is associated with another instance of the product.

Next, the computer may selectively provide a notification (operation 216) to the electronic device based at least in part on the product authenticity score.

In some embodiments, the computer may optionally perform one or more additional operations (operation 218). For example, the computer may analyze the information (such as the one or more images and/or the one or more measurements) to extract one or more authenticity features, which the computer uses to determine the product authenticity score. Alternatively or additionally, the computer may perform an action (such as notifying a manufacturer or owner of a brand associated with the product) based at least in part on the product authenticity score. Note that the information may include a characterization or measurement of the environment for use in a future authentication of the product (which is after or subsequent to the current authentication of the product).

FIG. 3 presents a flow diagram illustrating an example of a method 300 for verifying authenticity of a product using an electronic device, such as electronic device 110 or 112 (FIG. 1). During operation, the electronic device may obtain information (operation 310) that specifies an identifier of a product and: an environment that includes the product, and/or an individual associated with the product. For example, the electronic device may perform one or more measurements of the identifier (such as an optical measurement of the product, an optical measurement of a tag or a label associated with the product, a radio-frequency measurement of a radio-frequency identification tag associated with the product, and/or a near-field-communication measurement of the tag or label). Moreover, the electronic device may perform one or more measurements in the environment (such as a measurement that characterizes the environment and/or the individual).

Then, the electronic device may provide the information (operation 312) to a computer that specifies the identifier of the product and: the environment that includes the product, and/or the individual associated with the product.

Next, the electronic device may receive a notification (operation 314) from the computer, where the notification corresponds to a product authenticity score of the product.

In some embodiments, the electronic device may optionally perform one or more additional operations (operation 316). Notably, the electronic device may selectively perform an action based at least in part on the notification. For example, the electronic device may: cancel or discontinue a financial transaction (such as purchase of the product), provide an alert or display a message to the user, seize the product, and/or perform another action.

In some embodiments of methods 200 (FIG. 2) and/or 300, there may be additional or fewer operations. Furthermore, the order of the operations may be changed, there may be different operations and/or two or more operations may be combined into a single operation.

While the preceding embodiments illustrated determining of a product authenticity score for a product, in other embodiments the product authenticity score may be determined for a set of products (instead of an individual product). Thus, the analysis in the preceding embodiments may be performed in isolation, or on a population basis (by analyzing a set of similar product authenticity scores) to detect outliers.

FIG. 4 presents a drawing illustrating an example of communication among electronic device 110 and computer 120-1. During the authenticity verification techniques, a processor 410 in electronic device 110 may provide an instruction 412 to measurement device(s) 414 to acquire or measure information 416 that specifies an identifier 418 associated with a product, which is provided to processor 410.

Then, processor 410 may optionally determine identifier 418 for the product based at least in part on information 416. Moreover, processor 410 may optionally provide an instruction 420 to measurement device(s) 414 to perform one or more measurements 422 in an environment that includes the product (such as a measurement that characterizes the environment and/or the individual), and/or to acquire or measure one or more images 424 of the product and/or an associated tag, which are provided to processor 410.

Next, processor 410 may provide information 426 to interface circuit 428 in electronic device with an instruction to provide information 426 to computer 120-1. Note that information 426 may include or specify: identifier 418 and: an environment that includes the product, and/or an individual associated with the product. Moreover, information 426 may include or may specify results of the one or more measurements 422 and/or the one or more images 424.

After receiving information 426, an interface circuit 430 in computer 120-1 may provide information 426 to processor 432 in computer 120-1. Then, processor 432 may optionally determine identifier 418 for the product based at least in part on information 428 and/or may extract one or more authenticity features (AF) 434 based at least in part on information 426.

Moreover, processor 432 may access, based on identifier 418, stored information 438 about the product in memory 436 in computer 120-1. This stored information may specify: an expected environment, an expected type of individual, and/or a history of the product.

Furthermore, processor 432 may determine a product authenticity score (PAS) 440 based at least in part on a comparison of information 426 and information 438.

Next, processor 432 may selectively instruct 442 interface circuit 430 to provide notification 444 to electronic device 110. After receiving notification 444, interface circuit 428 may provide notification 444 to processor 410, which may selectively perform an action 446 based at least in part on notification 444.

While FIG. 4 illustrates communication between components using unidirectional or bidirectional communication with lines having single arrows or double arrows, in general the communication in a given operation in these figures may involve unidirectional or bidirectional communication.

We now further describe embodiments of the authenticity verification techniques. The authenticity verification techniques may add product authenticity capabilities to barcodes (such as 1D and/or 2D barcodes) and do not require more extensive dedicated physical markings. Instead, the authenticity verification techniques may add one or more layers of data on top of physical objects or products to improve the probability of confirming that a product is authentic and, conversely, to improve the probability of detecting a counterfeit product. This approach is sometimes referred to ‘data-driven product authenticity.’

In the authenticity verification techniques, product authentication may be or may involve a multi-layered process. This is shown in FIG. 5, which presents a drawing illustrating an example of product authentication. Notably, each level of authentication in FIG. 5 may provide additional authenticity checks and, thus, may reduce the possibility that a product is counterfeit.

In FIG. 5, identity generation 510 may provide an initial indication that a product is genuine. For example, a product may include a unique identifier, e.g., in a uniform resource identifier or another identifier that is printed on the product and/or on labeling or packaging associated with the product (such as a label or a tag). If the identity of the product can be confirmed using the unique identifier, then the product may be genuine.

Moreover, supplier activation 512 may be used to determine/verify whether or not a product was activated or logged in a data structure by the supplier. Information that a product, which was shipped by the supplier or manufacturer, was activated may provide a further indication that the product is genuine. Alternatively, a non-activated product that ends up being sold may be a back-door or an otherwise unauthorized sale. In some embodiments, item identity verification may use a business rule and/or a trained predictive model to handle cases of suppliers that shipped products, but that did not scan or log the identifiers of the products.

Then, matching product features 514 (such as physical and digital features) may be used to determine whether an actual product physically matches the expected product. This layer may use imaging and/or other physical determinations or measurements to check the product. For example, a customer may capture an image of the product, which may be compared with expected characteristics of the product (e.g., color, patterns, etc.) that are extracted from a stored product profile (e.g., which may be accessed using the product identity).

Layers 510-514 may be sufficient for data-driven product authenticity determination. However, additional layers of verification may be added. For example, in some embodiments similar products may also be checked for authenticity. Notably, products are often shipped in batches to a given geographic region. Consequently, similar products to a product may be scanned in relatively close temporal proximity to one another. Alternatively, a product that is scanned in a different geographic region may indicate a gray market or counterfeit market product.

In the authenticity verification techniques, authenticity of a product may be assessed by considering one or more aspects of the product, e.g., who made it, who ordered it, whether it is tagged correctly, did it arrive at the expected destination, who bought it, where were similar products bought, etc. Consequently, authenticity of a product may be based on one or more features that may be individually and/or collectively validated to provide a probabilistic assessment of the authenticity of the product.

For example, one or more features that may be used to determine authenticity may include the product itself and/or a product tag or label associated with the product. Note that a tag may be embedded in the product and/or attached to the product. A tag or label may include, encode and/or specify information about the product (e.g., size, content, etc.), as well as a unique identifier for the product. The information in/on a tag or label may be encoded in a machine-readable manner, such as in: a barcode (e.g., a 1D barcode, a QR code, etc.), a radio-frequency identifier tag (e.g., UHF EPC Gen2 from EPC Global of Brussels, Belgium, etc.), a near-field communication tag, etc. Each unique identifier may link the associated physical product to a corresponding stored digital profile for that product. A digital profile may include a product type description (which may be in human readable form) and/or a digital product fingerprint that may be used to authenticate the physical product. For example, the digital profile may include intrinsic and/or extrinsic properties of a product. Moreover, the digital profile may associate the product with a set of products or a type of product with common features.

Moreover, a profile of a product may also include a digital fingerprint of the tag or label that may be used, e.g., to make counterfeiting tags more difficult. Furthermore, a profile of a product may include a digital record of the lifecycle and/or history of the product, such as when the tag or label was attached to the product, when the product left a factory, when a product is scanned by a customer, etc. In authenticity verification techniques, the use of digital and/or physical information about a product may allow the product to be authenticated.

In some embodiments, a product may be considered to be authentic when the product and its tag or label are both considered genuine. In this disclosure, ‘genuine’ may be understood to mean that the manufacturing, distribution and sale of the product abided by terms agreed upon by all parties. This may mean that a product that was manufactured by a licensed supplier, but sold out the backdoor, is considered a counterfeit, even though this product may be indistinguishable from a genuine product.

Table 1 presents examples of authenticity evaluations of a tag or a label and a product. In Table 1, ‘stolen’ may include spontaneous theft (such as when an employee steals a product at a factory) and/or institutionalized theft (which may be sanctioned by management, e.g., a backdoor sales channel or distribution). Moreover, ‘counterfeit’ may indicate that a product and/or a tag or a label are imitations.

TABLE 1

| | | Tag/product | |
|---|---|---|---|
| Tag | Product | match | Description |
| Stolen | Stolen | Yes | A genuine tag or label placed on a genuine |
| | | | product. For example, a new tag or label was |
| | | | placed on the product by an unauthorized third |
| | | | party. In this case, the product may not have been |
| | | | activated, or the product was activated correctly, |
| | | | but was never scanned by an authorized point-of-sale |
| | | | or activation scanner. However, the tag or |
| | | | label product profile and the product profile |
| | | | match. |
| Stolen | Stolen | No | As described in the previous example, but the |
| | | | actual product type does not match the expected |
| | | | product type. |
| Stolen | Counterfeit | Yes | A genuine tag or label is placed on a counterfeit |
| | | | product. The tag or label product type matches |
| | | | that of the product. The history of the product |
| | | | contains irregularities (as described in the previous |
| | | | examples), and the visible characteristics of the |
| | | | product exhibit discrepancies. |
| Stolen | Counterfeit | No | As described in the previous examples, but the tag |
| | | | or label was placed on a product in the wrong type |
| | | | of product. |
| Counterfeit | Stolen | Yes | A copied tag is placed on a genuine product. The |
| | | | visual characteristics of the product differ from |
| | | | those of a genuine product. Furthermore, the |
| | | | history of the product shows irregular patterns. |
| Counterfeit | Stolen | No | As described in the previous examples, but the |
| | | | type of product does not match. |
| Counterfeit | Counterfeit | Yes | A counterfeit tag or label (containing a correct |
| | | | identifier) on a counterfeit product. While the type |
| | | | of product matches, the other discrepancies in the |
| | | | previous examples apply. |
| Counterfeit | Counterfeit | No | As described in the previous examples, but the |
| | | | type of product does not match. |
| Stolen | Counterfeit | No | As described in the previous examples, but the tag |
| | | | or label was placed on a product in the wrong type |
| | | | of product. |

In some embodiments, a product may be associated with a (digital) product identity using a uniform resource locator. The uniform resource locator may be encoded in a machine-readable way (such as a QR code). This approach may allow at least two factors to be used to authenticate a product, such as digital product data and physical attributes of a product.

The digital authentication of a product may apply or consider rules (e.g., business rules, such as that a product may only be purchased once) and/or may be based at least in part on patterns that are inferred over time. Note that the rules may be set up or predefined, e.g., by domain experts, the product manufacturer and/or a distributor.

Moreover, in some embodiments, physical authentication of a product may, e.g., be image based (e.g., using a one or more images of the product). For example, a product may be considered authentic when digital authentication and physical authentication are positive. Conversely, a product may be considered counterfeit (or not authentic) when either digital authentication or physical authentication is negative.

FIG. 6 presents a drawing illustrating an example of a product-authentication architecture. In FIG. 6, computer 120-1 may include a product authentication engine or PAE 610 (such as hardware and/or a set of instructions). This product authentication module may authenticate a product based at least in part on its digital and physical attributes, e.g., using digital authentication engine or DAE 612 (such as hardware and/or a set of instructions) and physical authentication engine or PA 614 (such as hardware and/or a set of instructions).

Note that digital authentication engine 612 and/or physical authentication engine 614 may take one of inputs 618 in data structure 616, e.g., a state of a product record, and return a value (e.g., equal to or between 0 and 1) to indicate a probability that a product is authentic. Product authentication engine 610 may execute authentication components and may combine the output authentication values (such as by taking their average) to determine a product authenticity score. Note that the product authenticity score may be stored by an output engine (such as hardware and/or a set of instructions) in one of outputs 620 in data structure 616.

An entry point to data-driven product authenticity may be a tag or label (e.g., a 2D barcode) associated with a product and that contains or encodes a uniform resource indicator. The uniform resource indicator may be a digital address of a resource that represents the product in the web. Note that product authentication may be accessed if a product that is being scanned has not yet been authenticated. In some embodiments, the routing may be determined by a context-aware rule-engine. In these embodiments, context may be a state of the resource that represents the scanned product, and information that a user submits as part of web-browser information and location. This entry point may activate the digital authentication component, while physical authentication may be activated when the user submits an image of the product.

Moreover, digital authentication engine 612 may include one or more models designed for specific use cases. The one or more models may obtain input data 618 from an input engine (such as hardware and/or a set of instructions), e.g., current or past state(s) of products, catalog metadata and/or information from external sources. Note that the one or more models may be symbolic or non-symbolic. Symbolic rules may be written in a formal representation of business logic (which may be human readable). For example, a rule may be: if (item.leftfactory=true) then return ‘1’, else return ‘0’. Furthermore, non-symbolic rules may be based at least in part on machine learning. Machine-learned rules may be automatically distilled from training data. For example, anomaly detection may be used to discover unusual product scan behaviors by customers (which may be an indication, e.g., of parallel imports).

Additionally, physical authentication engine 614 may use a visual fingerprint of the product, e.g., an image of the product (which may be acquired using a cellular telephone). The visual fingerprint may then be compared to a stored or otherwise known fingerprint of the product. During this comparison, the product may be matched to a known product fingerprint for that type of product. Note that determining the type of product may be possible, because computer 120-1 may know or have access to the tag or label of the product that is being sold.

In some embodiments, computer 120-1 may use one or more predictive models, which may be pretrained using one or more known images of the product. This training may be performed by the product manufacturer or provider, or crowd-sourced, and the one or more predictive model may be provided to computer 120-1. During physical authentication, the one or more predictive models may be used to analyze one or more submitted images of the product to determine a probability distribution over products known by the one or more physical models. Then, the one or more physical models may provide a value for the type of product contained in the one or more submitted images. If the one or more submitted images are of the correct product, the product authenticity score may be increased. Otherwise, the product authenticity score may be lowered (possibly significantly).

In FIG. 6, inputs 618 may include product resource and product-type resource profiles, and events and actions representing interactions of resources with their environment(s). Note that the actions may include, e.g., a scan by a user. Moreover, events may, e.g., be triggered when a product is shipped, which changes an intrinsic state of a product. Furthermore, inputs 618 may include one or more user profiles. These user profiles may help determine if a product has been authenticated or not, or if a new user is using a product that has already been authenticated. In some embodiments, external data sources may be used, such as a report of weather conditions, which may be used to identify seasonal trends, a location, etc.

Additionally, outputs 620 may include a result of product authentication activities. Note that the operations in the product authentication workflow may result in one or more actions. The one or more actions may be aggregated to create one or more additional actions. Moreover, the one or more actions may trigger rules, either for data analysis or to trigger logic. For example, a rule may warn of increasing counterfeit activities in a certain region.

FIG. 7 presents a flow diagram illustrating an example of a method 700 for verifying authenticity of a product using an electronic device in FIG. 1 (such as electronic device 110 in FIG. 1) and a computer in FIG. 1, such as one of computers 120 (FIG. 1). During this method, a user (such as a consumer, a brand employee, a retailer, etc.) may scan or acquire an image of a product tag or label to obtain/determine an identifier of the product. For example, the tag or label may include a 2D barcode (e.g., a QR code) encoding or containing a uniform resource indicator or a link that includes the identifier of the product. In some embodiments a generic native QR code reader application may be used. However, one problem with a generic application is that counterfeit tags that do not contain a valid identifier may not be detected using this approach. This is because a counterfeit tag or label is effectively a ‘man in the middle’ attack. Consequently, if a counterfeiter copies a product but also the tag or label and the digital experience, a customer may be misled into believing the product is genuine.

During method 700, if a uniform resource indicator obtained from the tag or label includes a valid uniform resource locator or URL (operation 710), then the uniform resource locator may be resolved (operation 712). For example, if the uniform resource locator has the correct format or form (i.e., is valid), the uniform resource locator may be resolved using a domain name system server. Otherwise, no further action may be taken (operation 714).

If the product has already been activated by the same user/customer, the user may be redirected to a web page (operation 716) or a user interface (UI) other than the product authentication user interface. Alternatively, if the product has not been activated yet (which means it should not be on the market or the product has been reported as stolen), the user may be informed that the product is not genuine (operation 718). If the product has been legitimately acquired, the user may be redirected to a product authentication web page or user interface (operation 720), which may be associated with a product authentication web-based application.

During product authentication (operation 720), the authenticity of a product may be verified. Notably, a product authentication engine may determine a product authenticity score (such as a probability or value) that indicates the authenticity or genuineness of the product.

Note that physical aspects of the product may be obtained by analyzing an image of the product (which may be acquired by the electronic device) and determining a digital fingerprint from the image of the product. Each product may belong to a type of product that is associated with a digital product fingerprint, to which the determined product fingerprint may be compared. Fingerprints for types of products may be obtained, e.g., by training a neural network using images of products.

In some embodiments, the product authentication is based at least in part on data for an individual and/or the environment that includes the product (such as one or more measurements of or associated with the individual and/or the environment, e.g., captured sound of the individual and/or in the environment). Thus, in some embodiments, the product authentication is based at least in part on data for one or more individuals or objects that are other or different than the product and/or its associated tag or label.

Moreover, a context of a product may be analyzed (operation 722) to determine whether or not the product is authentic. This may include analyzing supply chain data, such as: a supplier, a store or region for which the product was created, user reviews, etc. This information may be used to extract patterns for forecasting, anomaly detection, etc. In some embodiments, the context may be determined using traceability data from and about the product, stored in a data structure and/or derived from stored data. The context of the product may include, e.g., whether the product was activated at manufacturing time, information related to transportation of the product, etc. Note that missing and/or contradictory data may provide an indication of a fraudulent or an unauthorized product.

During the analysis of the context of the product (operation 722), the computer may leverage explicit and implicit information collected about individual products to create a holistic picture of a lifecycle of a product. The analysis may be performed to identify out of the ordinary events that may indicate counterfeit market activity. For example, the analysis may use or include customer satisfaction, such as: How satisfied were customers who bought a similar product? A customer who unknowingly bought a low-quality counterfeit may be more likely leave a negative review. Moreover, the analysis may use or include customer scans, such as: Where customers scan their products. The aim may be to detect outliers. A product scanned in an unexpected region may indicate a possible counterfeit (or parallel import). Furthermore, the analysis may use or include manufacturing or supply chain scans, such as scans that happened at manufacturing time or in the supply chain. A product that was not scanned at the manufacturing facility or at a particular point in the supply chain may potentially identify a gray market or backdoor goods item. The context analysis may produce a context score (such as a probability or value) indicative of whether the context is considered anomalous (a lower score) or normal (a higher score).

Furthermore, a user may be asked to acquire or reacquire an image of the product, because scanning a QR code with a generic QR reader may not automatically send an image to the product authentication web page or user interface. The computer may compare the content of the image with expected properties, which may include a product fingerprint. Notably, the computer may analyze a tag or label (operation 724), such as one or more visual properties, e.g., image entropy, structural elements, font types, branding, where the product was manufactured, etc. Additionally, the computer may analyze the product (operation 726), including the visual properties of the product, such as a type of product (if the full product is visible, color, image entropy, etc.). Note that the tag or label analysis (operation 724) may produce a tag or label fingerprint score (such as a probability or value, with a higher value indicative of a greater likelihood of being authentic or genuine). The product analysis (operation 726) may produce a product fingerprint score (such as a probability or value, with a higher value indicative of greater likelihood of being authentic or genuine).

Additionally, the computer may determine a product authenticity score (operation 728) using one or more of the scores determined by the context analysis (operation 722), the tag or label analysis (operation 724) and/or the product analysis (operation 726). In some embodiments, the product authenticity score may be a weighted sum of the context score, the tag or label fingerprint score and/or the product fingerprint score. Note that the sum of the weights may be normalized to a value of one. The weights may be used to give more value or credence to one or more of the scores. Alternatively, the scores may have equal weights.

If the product authenticity score is above a threshold value, then the product may be considered to be genuine (operation 730). Otherwise, the product may be deemed to be a counterfeit (operation 718), with the user appropriately informed.

In some embodiments, method 700 may use a dedicated application or scanner. This may remove the possibility of a man-in-the-middle attack, because a uniform resource indicator for an invalid product identity may be recognized, thereby removing the risk of counterfeiters using their own product identities. Moreover, the system in method 700 may operate in real-time (including near real-time or sufficiently real-time). For example, there are inherent delays in electronic components and in network-based communication (e.g., based on network traffic and distances), and these delays may cause delays in data reaching various components. Inherent delays in the system may not change the real time nature of the data. In some embodiments, the term ‘real-time data’ may refer to data obtained in sufficient time to make the data useful for its intended purpose. Note that real-time computation may refer to an online computation (as opposed to offline or batch computation), e.g., a computation that produces its answer(s) as data arrive, and generally keeps up with continuously arriving data.

FIG. 8 presents a drawing illustrating an example of a product authentication. During the product authentication, a user may scan a QR code 810 of a product (such as a garment, e.g., a shirt) using a generic QR reader, such as the default camera application, in order to access the uniform resource locator of a data-driven product authentication web page or user interface. For example, the uniform resource locator may include an identifier, such as a valid GS1 digital link, which may include the product type number and the product serial number.

Then, a dialog or user interface may provide the user with product information and a user-interface icon (such as a button) to continue the authentication process by scanning product 812. Moreover, the accessed uniform resource locator may lead to a ‘scan action’. A scan action may occur when user scans (for the first time) a product (such as a shirt) the user bought, with the intention of performing authentication. Note that certain types of products are usually sold and scanned in the same retail establishments(s). This means that, if a shirt is being scanned in an unusual space, this may indicate grey market activity. Therefore, the location of a scan provides one factor in the multi-factor product authenticity score. In some embodiments, a random forest model may be trained on a set of existing scan actions to automatically classify the actions. Moreover, the classified actions may be used as training data to train a simple fully connected neural network to learn whether or not a user scan location is anomalous. When deployed, the neural network may perform binary classification, returning a value between 0 and 1. For example, the larger the output value, the less likely the user scan is an anomaly. In some embodiments, the neural network model may run on a cloud-based machine learning engine.

In order to authenticate the product, the user may select ‘scan to authenticate’ in the user interface. In response, the user may be asked to take one or more pictures or to acquire one or more images 814 of the product and to provide it to computer 120-1 (or computer system 122). Then, a visual product search may be performed (using a pre-trained image recognition engine) for the image submitted by the user. If the product type identified in the image matches the product type that the user bought, a match probability may be return. Otherwise, a value of ‘0’ may be returned. When the user scan classification and the product identification are complete, the average of the aforementioned authenticity values and the binary property supplier scan (whether or not this product officially left the factory or was stolen) may provide a product authenticity score 816 of the product. Note that each product type may have an associated authenticity threshold value. If the product authenticity score 816 exceeds that threshold value, the product may be considered to be authentic.

As discussed previously, in some embodiments the authenticity verification techniques perform comparisons to stored information. FIG. 9 presents a drawing illustrating storage of information associated with a product. Notably, when a product is manufactured or fabricated at a factory, different operations may be performed. For example, a product may be activated in the system, which may lead to a unique product identifier being assigned. Moreover, enterprise data associated with the product (such as metadata) may be stored. Furthermore, environmental signature authentication may lead to data being stored, such as: voice pattern(s) of one or more individuals in one or more expect environments, sound associated with the one or more expected environment(s) and/or visual authentication information of the one or more individuals. Furthermore, during product authentication, a user may scan or acquire information using an electronic device, such as: a QR code (and, more generally, an identifier associated with the product); one or more images of the environment, an individual, the product and/or a tag or label of the product; and/or environmental measurements (such as sound, voice, etc.), which can be used to confirm that the product is in a normal or expected environment. In some embodiments, a voice signature of a current owner or user of the product can be used to reject voice or speech that is captured for another individual who is not associated with the product.

The comparison with stored information is further illustrated in FIG. 10, which presents a drawing illustrating an authenticity assessment of a product. Notably, at a factory, an active digital identifier may be assigned and enterprise data may be stored in a data structure. This information may be subsequently used during an assessment of product authenticity (or during product authentication), such as during product identification. Moreover, during product authentication, a user may scan or acquire information using an electronic device, such as: a QR code (and, more generally, an identifier associated with the product); one or more images of the environment, an individual, the product and/or a tag or label of the product; and/or environmental measurements (such as sound, voice, etc.). These actions by the user may result in a scan action that determines or access the product location and a stored device profile. Next, the direct or indirect user information may be used during the assessment of product authenticity (or during product authentication), such as during the product identification and/or as inputs to one or more predictive models. For example, the factory generated information can uniquely identify the product and to increase the probability that a duplicate identifier will not match the actual code for a particular product. Notably, an identifier may represent a product having a particular color, but a physical scan or an image of the product during product authentication may have a different color. Alternatively, the environment of use specified by one or more measurements in the environment of the product may not match an expected environment.

Furthermore, as discussed previously, in some embodiments the authenticity verification techniques may use one or more authenticity features. This is shown in FIG. 11, which presents a drawing illustrating an authenticity assessment of a product using an environmental signature. Notably, during environmental signature authentication one or more authenticity features (such as a background noise signature, a voice signature, a temperature, a location, an elevation, visual scanning and/or one or more images, environmental data or measurements that are acquired at the time of scanning, etc.) may be used to determine a product authenticity score. Once again, in some embodiments, a voice signature of a current owner or user of the product can be used to reject voice or speech that is captured for another individual who is not associated with the product and, thus, to improve the accuracy of the determined product authenticity score.

In summary, the authenticity verification techniques may not require changes to the manufacturing process. Moreover, the product authentication may improve over time as more data is collected and models are improved. The authenticity verification techniques may work for backdoor sales and gray market imports, where products are technically authentic but sold illegally. Thus, the authenticity verification techniques may provide multi-factor product authentication based at least in part on digital and physical characteristics as well as machine learning to determine the authenticity of a product.

We now describe embodiments of an electronic device, which may perform at least some of the operations in the authenticity verification techniques.

FIG. 12 presents a block diagram illustrating an example of an electronic device 1200 in accordance with some embodiments, such as electronic device 110, electronic device 112, access point 114, base station 116, one of computers 120, etc. This electronic device includes processing subsystem 1210, memory subsystem 1212, and networking subsystem 1214. Processing subsystem 1210 includes one or more devices configured to perform computational operations. For example, processing subsystem 1210 can include one or more microprocessors, ASICs, microcontrollers, programmable-logic devices, one or more graphics process units (GPUs) and/or one or more digital signal processors (DSPs).

Memory subsystem 1212 includes one or more devices for storing data and/or instructions for processing subsystem 1210 and networking subsystem 1214. For example, memory subsystem 1212 can include dynamic random access memory (DRAM), static random access memory (SRAM), and/or other types of memory. In some embodiments, instructions for processing subsystem 1210 in memory subsystem 1212 include: one or more program modules or sets of instructions (such as program instructions 1222 or operating system 1224), which may be executed by processing subsystem 1210. Note that the one or more computer programs may constitute a computer-program mechanism. Moreover, instructions in the various modules in memory subsystem 1212 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1210.

In addition, memory subsystem 1212 can include mechanisms for controlling access to the memory. In some embodiments, memory subsystem 1212 includes a memory hierarchy that comprises one or more caches coupled to a memory in electronic device 1200. In some of these embodiments, one or more of the caches is located in processing subsystem 1210.

In some embodiments, memory subsystem 1212 is coupled to one or more high-capacity mass-storage devices (not shown). For example, memory subsystem 1212 can be coupled to a magnetic or optical drive, a solid-state drive, or another type of mass-storage device. In these embodiments, memory subsystem 1212 can be used by electronic device 1200 as fast-access storage for often-used data, while the mass-storage device is used to store less frequently used data.

Networking subsystem 1214 includes one or more devices configured to couple to and communicate on a wired and/or wireless network (i.e., to perform network operations), including: control logic 1216, an interface circuit 1218 and one or more antennas 1220 (or antenna elements) and/or input/output (I/O) port 1230. (While FIG. 12 includes one or more antennas 1220, in some embodiments electronic device 1200 includes one or more nodes, such as nodes 1208, e.g., a network node that can be coupled or connected to a network or link, or an antenna node or a pad that can be coupled to the one or more antennas 1220. Thus, electronic device 1200 may or may not include the one or more antennas 1220.) For example, networking subsystem 1214 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, a cable modem networking system, and/or another networking system.

Networking subsystem 1214 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1200 may use the mechanisms in networking subsystem 1214 for performing simple wireless communication between the electronic devices, e.g., transmitting advertising or beacon frames and/or scanning for advertising frames transmitted by other electronic devices as described previously.

Within electronic device 1200, processing subsystem 1210, memory subsystem 1212, and networking subsystem 1214 are coupled together using bus 1228. Bus 1228 may include an electrical, optical, and/or electro-optical connection that the subsystems can use to communicate commands and data among one another. Although only one bus 1228 is shown for clarity, different embodiments can include a different number or configuration of electrical, optical, and/or electro-optical connections among the subsystems.

In some embodiments, electronic device 1200 includes a display subsystem 1226 for displaying information on a display, which may include a display driver and the display, such as a liquid-crystal display, a multi-touch touchscreen, etc.

Electronic device 1200 can be (or can be included in) any electronic device with at least one network interface. For example, electronic device 1200 can be (or can be included in): a computer system (such as a cloud-based computer system or a distributed computer system), a desktop computer, a laptop computer, a subnotebook/netbook, a server, a tablet computer, a smartphone, a cellular telephone, a smartwatch, a consumer-electronic device, a portable computing device, an access point, a transceiver, a router, a switch, communication equipment, a computer network device, a stack of computer network devices, an access point, a controller, test equipment, and/or another electronic device.

Although specific components are used to describe electronic device 1200, in alternative embodiments, different components and/or subsystems may be present in electronic device 1200. For example, electronic device 1200 may include one or more additional processing subsystems, memory subsystems, networking subsystems, and/or display subsystems. Additionally, one or more of the subsystems may not be present in electronic device 1200. Moreover, in some embodiments, electronic device 1200 may include one or more additional subsystems that are not shown in FIG. 12, such as a user-interface subsystem 1232. Also, although separate subsystems are shown in FIG. 12, in some embodiments some or all of a given subsystem or component can be integrated into one or more of the other subsystems or component(s) in electronic device 1200. For example, in some embodiments program instructions 1222 are included in operating system 1224 and/or control logic 1216 is included in interface circuit 1218.

Moreover, the circuits and components in electronic device 1200 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 1214 (or, more generally, of electronic device 1200). The integrated circuit may include hardware and/or software mechanisms that are used for transmitting wireless signals from electronic device 1200 and receiving signals at electronic device 1200 from other electronic devices. Aside from the mechanisms herein described, radios are generally known in the art and hence are not described in detail. In general, networking subsystem 1214 and/or the integrated circuit can include any number of radios. Note that the radios in multiple-radio embodiments function in a similar way to the described single-radio embodiments.

In some embodiments, networking subsystem 1214 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Ethernet, a cellular-telephone communication protocol and a Wi-Fi communication protocol as an illustrative example, in other embodiments a wide variety of communication protocols and, more generally, wired and/or wireless communication techniques may be used. Thus, the authenticity verification techniques may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the authenticity verification techniques may be implemented using program instructions 1222, operating system 1224 (such as a driver for interface circuit 1218) or in firmware in interface circuit 1218. Alternatively or additionally, at least some of the operations in the authenticity verification techniques may be implemented in a physical layer, such as hardware in interface circuit 1218.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the authenticity verification techniques, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer, comprising:
a network interface configured to communicate with an electronic device;
a processor; and
memory configured to store program instructions, wherein, when executed by the processor, the program instructions cause the computer to perform operations comprising:
receiving information associated with the electronic device, wherein the information specifies an identifier of a product and at least one of: an environment that includes the product, or an individual associated with the product;
accessing, based at least in part on the identifier, stored second information about the product that specifies at least one of: an expected environment, an expected type of individual, or a history of the product;
determining a product authenticity score based at least in part on a comparison of the information and the second information; and
selectively providing a notification addressed to the electronic device based at least in part on the product authenticity score.

2. The computer of claim 1, wherein the product authenticity score indicates that the product is potentially fraudulent or is unauthorized when the environment is different from the expected environment.

3. The computer of claim 2, wherein the information specifies a location of the product and the expected environment comprises one or more predefined locations.

4. The computer of claim 2, wherein the information specifies one or more measurements in the environment; and
wherein the operations comprise analyzing the measurement to determine one or more attributes of the environment.

5. The computer of claim 4, wherein the measurement comprises at least one of: sound in the environment, an image of the environment, a temperature of the environment, a humidity of the environment, a barometric pressure of the environment, a magnetometer reading in the environment, or another measurement.

6. The computer of claim 1, wherein the product authenticity score indicates that the product is potentially fraudulent or is unauthorized when one or more attributes of the type of individual are different from the one or more attributes of the individual.

7. The computer of claim 7, wherein the one or more attributes comprise one or more of: a nationality, a gender, an age, an annual income, or another socioeconomic or demographic factor.

8. The computer of claim 7, wherein the information comprises recorded speech of the individual; and
wherein the operations comprise performing voice recognition of the individual based at least in part on the recorded speech.

9. The computer of claim 1, wherein the product authenticity score indicates that the product is potentially fraudulent or is unauthorized when the history of the product indicates that the product has been previously sold.

10. The computer of claim 1, wherein the information comprises one or more images of the product, a tag or label associated with the product, or both.

11. The computer of claim 10, wherein the second information comprises one or more predetermined images of the product, the tag or the label associated with the product, or both; and
wherein the product authenticity score indicates that the product is potentially fraudulent or is unauthorized when the one or more images are different from the one or more predetermined images.

12. The computer of claim 10, wherein the second information comprises one or more predetermined images of the product, the tag or the label associated with the product, or both; and
wherein the product authenticity score indicates that the product is potentially fraudulent or is unauthorized when third information about the product included in or specified by the one or more images is different from the third information about the product included in or specified by the one or more predetermined images.

13. The computer of claim 1, wherein the information comprises third information associated with a tag or a label associated with the product; and
wherein the product authenticity score indicates that the product is potentially fraudulent or is unauthorized when the third information is associated with another instance of the product.

14. The computer of claim 1, wherein the information comprises a characterization or measurement of the environment for use in a future authentication of the product.

15. A non-transitory computer-readable storage medium for use in conjunction with a computer, the computer-readable storage medium storing program instructions that, when executed by the computer, cause the computer to perform operations comprising:
receiving information associated with an electronic device, wherein the information specifies an identifier of a product and at least one of: an environment that includes the product, or an individual associated with the product;
accessing, based at least in part on the identifier, stored second information about the product that specifies at least one of: an expected environment, an expected type of individual, or a history of the product;
determining a product authenticity score based at least in part on a comparison of the information and the second information; and
selectively providing a notification addressed to the electronic device based at least in part on the product authenticity score.

16. The non-transitory computer-readable storage medium of claim 15, wherein the product authenticity score indicates that the product is potentially fraudulent or is unauthorized when the environment is different from the expected environment.

17. The non-transitory computer-readable storage medium of claim 16, wherein the information specifies one or more measurements in the environment; and
wherein the operations comprise analyzing the measurement to determine one or more attributes of the environment.

18. The non-transitory computer-readable storage medium of claim 15, wherein the product authenticity score indicates that the product is potentially fraudulent or is unauthorized when one or more attributes of the type of individual are different from the one or more attributes of the individual.

19. The non-transitory computer-readable storage medium of claim 15, wherein the product authenticity score indicates that the product is potentially fraudulent or is unauthorized when the history of the product indicates that the product has been previously sold.

20. A method for performing authenticity verification, comprising:
by a computer:
receiving information associated with an electronic device, wherein the information specifies an identifier of a product and at least one of: an environment that includes the product, or an individual associated with the product;
accessing, based at least in part on the identifier, stored second information about the product that specifies at least one of: an expected environment, an expected type of individual, or a history of the product;
determining a product authenticity score based at least in part on a comparison of the information and the second information; and
selectively providing a notification addressed to the electronic device based at least in part on the product authenticity score.
